(19) United States
(12) Patent Application Publication
(10) Pub. No.: US 2010/0120465 A1
(43) Pub. Date: May 13, 2010

(54) Method for Mobile Advertisement Using Mobile Terminal and Mobile Terminal and Mobile Advertisement System Implementing the Same Method

(75) Inventor: Yoo Kyun Chung, Seoul (KR)

Correspondence Address: WOOD, HERRON & EVANS, LLP, 2700 CAREW TOWER, 441 VINE STREET, CINCINNATI, OH, 45202, US

(73) Assignee: ADISON CO., LTD., Seoul (KR)

(21) Appl. No.: 12/532,777

(22) PCT Filed: Jun. 30, 2008
(86) PCT No.: PCT/KR2008/003833

§ 371 Date: Sep. 23, 2009

(30) Foreign Application Priority Data
Jun. 29, 2007 (KR) 10-2007-0065599

(51) Int. Cl. G06Q 30/00; H04M 1/00

(52) U.S. Cl. 455/550.1; 705/14.41

(57) ABSTRACT

The present invention relates to a method for mobile advertisement using a mobile terminal and a mobile terminal for mobile advertisement and a mobile advertisement system. Provided is a mobile advertisement method by making use of a mobile terminal including an advertisement output unit outputting a mobile advertisement made of one or more among media consisted of a taste, a smell, a sound, an image or the combinations of them to the outside, and a population number measuring unit measuring the population number existing within a specified range of the surroundings; and an advertisement relay server which collects the mobile advertisement from an advertiser's terminal to manage with a member information, the mobile advertisement method comprising: an advertisement setting step of transmitting the mobile advertisement to the mobile terminal and managing a transmission list by the advertisement relay server, and deciding an output condition of the transmitted mobile advertisement; an advertisement execution step of outputting the mobile advertisements to the outside through the advertisement output unit by the mobile terminal, when the output condition is satisfied; a population number measuring step of measuring the population number of the surroundings of a mobile terminal by using the population number measuring unit when the mobile advertisement is outputted to the outside; and an advertisement result managing step of computing and managing an advertisement result classified by members who performed the advertisements execution step, after the advertisement relay server receives the measured population number, and changes it into a weight.

### TECHNICAL FIELD

The present invention relates to a method for mobile advertisement using a mobile terminal and a mobile terminal and mobile advertisement system implementing the same method, more particularly, to a method for mobile advertisement using a mobile terminal, which allows the advertisement relay server to reliably determine the advertising impact of the mobile advertisement output by the member's mobile terminal and the mobile terminal and mobile advertisement system implementing the same method.

### BACKGROUND ART

Recently, a mobile terminal like a mobile phone, a PDA, and a notebook computer does not function merely as a communications means such as a mobile communications or a wireless internet, but it is developed for various means besides communication such as for camera, gaming and navigation means.

Such function diversification of the mobile terminal is closely related to the development of multimedia technology. For instance, the mobile terminal includes a built-in timer enabling alarm watch function; moreover, it is able to be used as a mobile imaging device or a mobile sound source player by outputting images of high definition and sound sources of high-quality. In addition, it can be used as a location guide system for vehicles and pedestrians by mounting GPS; furthermore, it is able to be used for stress therapy by emitting aroma.

Relating to the aroma emitting technology through the mobile terminal, KR Laid open Patent 2006-7125 is known to public, and suggests a mobile terminal which installs an aroma generating element in between two PAM, which processes the transmission of data, and the vicinity of the PAM, and emits the aroma by using the heat generated in the PAM. Particularly, according to the temperature, the fragrance or the concentration emitted can vary. The mobile terminal, which uses replaceable aroma cartridges, radiates aroma in order to provide stress relief to the user of the terminal.

As the function of the mobile terminal varies and its multimedia becomes more powerful, the idea of utilizing the sounds or images that are outputted through the mobile terminal as a mobile advertisement means is proposed. As an example of mobile advertisement means by utilizing the mobile terminal, the marketing technique that utilizes the stand-by screen of a mobile telephone or PDA, and the ring tone or the ring back-tone as a mobile advertisement means can be given.

The KR Laid-open Patent 2007-18296 (hereinafter, “prior art document 1”) on the mobile communications server providing an advertisement service and method of operating the server is an advertising method using a mobile terminal. According to the prior art document 1, the idea that the service control message and the advertisement contents are transmitted to the mobile communications terminal of the commercial service subscriber, and the advertisement content is continuously controlled to be performed by the mobile communications terminal through the service control message during a predetermined period so that the mobile communications terminal user can be provided with mobile fee reduction through advertisement content execution and that the mobile carrier can maximize the advertising effect is proposed.

Upon detailed inspection of the method of providing an advertisement service according to the prior art document 1, the method includes the steps of maintaining a subscriber database in which subscriber information for the advertisement service subscriber and the service information corresponding to the subscriber information are recorded; maintaining a contents database in which one or more advertisement contents are recorded; extracting predetermined service information from the subscriber database and generating a service control message including the extracted service information; controlling the set-up of the function of the mobile communications terminal by transmitting the service control message to the mobile communications terminal of the subscriber corresponding to the service information; and extracting a predetermined advertisement contents from the contents database to transmit to the mobile communications terminal, wherein the service control message controls the set-up of the function of the mobile communications terminal in such a manner that the advertisement contents is continuously performed during a period according to the advertisement service validity period information, while the mobile communications terminal performs an operation including the steps of receiving the service control message and the advertisement contents from the mobile communications server to record in a predetermined memory means; controlling the advertisement contents to be continuously performed until the validity period according to the advertisement service validity period information is expired by reading the service information included in the service control message; receiving the command of the change of the advertisement contents execution from a user; reading the advertisement service validity period information from the service information included in the service control message recorded in the memory means; in case it is determined that the term of validity is not expired as a result of reading, displaying a message on the disallowance of alteration of the advertisement content execution to the user; and, in case it is determined that the term of validity is expired as a result of reading, expiring the execution of the advertisement contents.

As described, the prior art document 1 suggests the technology that utilizes the stand-by screen of the mobile communications terminal, the ring tone or the ring back tone as advertisement contents. Besides sound, the technology that utilizes the multimedia function of the recent mobile terminal is given in KR Laid open Patent 2001-112795 (hereinafter, “prior art document 2”).

As to the multimedia terminal according to the prior art document 2, the multimedia terminal having a transceiver that transmits and receives multimedia such as sound, data, and image, and a data processing means that processes various data after receiving the multimedia data by wire or wirelessly through the switching center or the base station which is connected by wire or wirelessly to the public switched telephone network, the mobile radio communications network, the internet network, and satellite communications network includes an input means inputting various data such as a voice, a data and an image; an advertisement setting means which sets up the re-generation of the multimedia advertisement such as a voice, a data and an image stored in the storage device of the computer installed at the switching center or the base station or the multimedia advertisement stored in the memory of the multimedia terminal; a status detecting means that detects whether the state of the multimedia terminal is stand-by status, sending or receiving status, or conversation status; and an output means that outputs the multimedia advertisement, while the multimedia advertisement is regenerated through the output means with one of the following among a stand-by advertisement, a sending or receiving advertisement, or a conversation advertisement according to the status detected by the status detecting means.

The multimedia terminal, according to the prior art document 2, has the ability to advertise aurally and visually to a communications user.

In addition, KR Laid open Patent 2002-75117 (hereinafter, “prior art document 3”) on the advertisement/publicity target customer selection method using a wireless terminal suggests the advertisement/publicity target customer selection method using a wireless terminal. Particularly, the prior art document 3 provides the idea which can improve the faith of a client according to the transmission of a selective advertisement message while preventing the overflow of the indiscriminate advertisement message, by selectively extracting a man who has a high probability of moving while carrying the wireless terminal or a high probability of directly reacting to the advertisement message which is transmitted through the wireless terminal while staying at a specific area for a certain time, and transmitting to this particular man an advertisement message which an individual enterprise requested both to prevent excessive advertisements messages and also raising the man's trust in the advertisement through selective advertisement message relay. Furthermore, the prior art document 3 presents the business model capable of expecting advertisement cost reduction while maximizing advertising effect by transmitting the selective advertisement message to a target desired by an individual enterprise, that is, to the client who is extracted by the selection process.

In this way, the idea to utilize the various multimedia functions which the mobile terminal has for an advertisement has been very much presented. However, the ideas in these prior arts have the following limitations.

Firstly, the prior arts including prior art document 1 and prior art document 2 do not take notice of the point that the advertisement using the mobile terminal is a mobile advertisement. That is, the stand-by screen or the advertisement using the ring tone which are mentioned in the prior art document 1 is not just a screen that the user oneself of the mobile terminal sees and hears, but a multimedia that can be exposed to others anywhere when the user uses a mobile terminal. Therefore, it can be used as an advertisement exposure means such as a moving display panel or TV.

In addition, prior art document 2 subdivides the multimedia advertisement using the mobile terminal as a stand-by, a sending and receiving advertisement, but it does not take notice of the point that it can function as a mobile advertisement depending on the surrounding environment where these advertisements are exposed. Due to the limitations as described above, both prior art document 1 and prior art document 2 do not recognize the point that the advertisement result should be evaluated differently depending on the condition of the surrounding environment where the multimedia advertisement outputted from the mobile terminal is exposed.

As suggested in prior art document 1, in the case where a company provides a fee discount benefit to the user of the mobile terminal who sets and outputs the advertising music of the company, from the point of view of the company, who must provide the fee discount benefit, the advertising result of the company's medium is indeterminate. This is also the case for prior art document 2, where the advertiser is unable to determine the advertising result from the mobile device, it is not possible to evaluate the value of the benefit dependent on the advertising result, and is unable to improve advertisement participation of the user as it does not reflect into the benefit the fact that the advertisement result can differ depending on the user.

Particularly, in the case that smell, a media which is not predicted at all in the prior art documents 1 or 2, is utilized as an advertisement means, despite the fact that it is very important to the advertiser to determine the result of the smell advertisement into the surroundings to pay the advertisement cost, prior art documents 1 and 2 cannot provide a solution to this problem, and the same problem exists for mobile image or mobile sound advertisements.

Additionally, for the case the advertisement occurs in a mobile terminal as in the case of prior art document 3, the point that the mobility of the mobile terminal user has to be considered is addressed. However, because the advertisement message described in prior art document 3 is an advertisement which is limited to the advertisement receiving mobile terminal user oneself, prior art document 3 has the limit of being unable to handle the even the very concept of a mobile advertisement, which utilizes a mobile terminal's multimedia functions to broadcast advertising effect to people in the mobile terminal user's surrounding . This is the same in case of the prior art documents 1 and 2. None among prior art document 1 through prior art document 3 handle the point that the advertisement has to take into consideration the specific nature of a mobile advertisement, nor does any among prior document 1 through prior art document 3 suggest a detailed advertisement method which is suitable for the specific nature of a mobile advertisement.

### DISCLOSURE OF INVENTION

### Technical Problem

The invention has been designed to solve the above-mentioned problems, and has determined that an advertisement using a mobile terminal is a mobile advertisement, and takes into consideration that the situation for each mobile advertisement changes constantly. The objective of the invention is to provide a mobile advertisement method using a mobile terminal which is suitable for the special circumstances that is a mobile advertisement. Further, another objective of the invention is to provide the mobile terminal for the mobile advertisement and the mobile advertisement system capable of implementing the above mobile advertisement method.

### Technical Solution

In order to achieve the above-mentioned object, according to the first aspect of the invention, provided is a mobile advertisement method making use of a mobile terminal including an advertisement output unit outputting mobile advertisements made of one or more media consisting of a taste, a smell, a sound, an image or a combination of them to the outside, and a population number measuring unit measuring the number of population existing within a specified range of the surroundings; and an advertisement relay server which collects the mobile advertisements from an advertiser's terminal to manage together with member information, the mobile advertisement method comprising: an advertisement setting step of transmitting the mobile advertisements to the mobile terminal and managing a transmission list by the advertisement relay server, and deciding an output condition of the transmitted mobile advertisements; an advertisements execution step of outputting the mobile advertisements to the outside through the advertisement output unit by the mobile terminal when the output condition is satisfied; a population number measuring step of measuring the number of population of the surroundings of a mobile terminal by using the population number measuring unit when the mobile advertisements is outputted to the outside; and an advertisement result managing step of computing and managing an advertisement result after the advertisement relay server receives the measured population number and changes it into a weight and classifying the advertisement result by members who performed the advertisements execution step. That is, the present invention first considers the population number of the environment, which is part of the constantly changing element of the mobile advertising environment. When the mobile advertisement consisting of the media including a smell, a sound, an image or a combination of the above is outputted through the mobile terminal, it is reasonable to acknowledge that the larger the number of population exposed to the advertisement, the larger the advertising impact. Hence, the present invention suggests, for a mobile terminal having a population measuring unit, the idea of measuring the population number, which is transmitted to the advertisement relay server so that it might be reflected as a weight in managing the advertising impact by the advertisement relay server.

According to the first aspect of the invention, the mobile terminal further comprises a noise measuring unit measuring a noise consisted of a smell, a sound, an image or a combination of the them existing within a specified range of the surroundings, further comprising a noise measuring step of measuring the noise of the surroundings of a mobile terminal by using the noise measuring unit when the mobile advertisements is outputted to the outside, wherein the advertisement relay server receives both the measured noise and the measured population number from the mobile terminal, and changes them into a weight.

Such configuration considers the surrounding noise in addition to the constantly varying population number of the mobile advertisement environment and takes into account the situation that no matter how many people are present in the surroundings, if one cannot distinguish the sound, image, smell relating to the mobile advertisement due to the surrounding noise when the mobile advertisement is performed, such noise is considered as a negative element in evaluating the advertising impact. In other words, the present invention considers the external environmental visual, aural and olfactory noise, which stimulates the senses of human including sight, hearing, smell, and taste etc, to dilute and lower the advertising effect of the advertising media, and reflects this into the evaluation of the mobile advertisement. Here, the means for measuring the noise of the environment differs according to the medium type of the mobile advertisement. For instance, in case of a sound media type mobile advertisement, the noise measuring unit can be a microphone which can measure the ambient noise. In case of an image type mobile advertisement, an optical sensor measuring the quantity of light of the surrounding of the mobile terminal is preferred. In case of olfactory or gustatory mobile advertisements, the noise measuring unit can be implemented accordingly.

In addition, in case of the mobile advertisement method according to the first aspect of the present invention, it is further preferred that the specified range in which the population number measuring unit measures the number of population is differentially set up according to the level of the noise measured in the noise measuring unit.

That is, in the case that both the population number and the noise of surroundings of the mobile terminal are considered simultaneously, the range that the advertising impact of the mobile advertisements reaches is limited according to the level of the surroundings noise and the mobile terminal measures the population number within the limited surroundings. In that way, a more exact advertising impact management is made possible. For example, even if the default value of the specified range which measures the population number of the surroundings is set up as 10 m when the mobile advertisements is outputted, it is possible that the noise of surroundings is so loud that the sound of the mobile advertisements may not be heard by a man positioned at a 10 m distance. Therefore, the advertising impact at the time in which the mobile advertisements is outputted can be accurately determined when the number of population is measured by differentially setting the range according to the noise of surroundings. The level of the noise can be indicated by the publicly known measurement method which digitizes the sense of sight, hearing, smell, taste or the combinations of them.

In the meantime, according to the mobile advertisement method according of the first aspect of the present invention, it is preferable that the population number measuring unit includes a local area network means which is capable of communicating with other mobile terminals existing within a specified range, and the number of population is defined as the number of mobile terminals measured by the local area network means. In addition, the local area network means includes an infrared communications means which determines the number of the mobile terminal by the infrared communications. More preferably, although existing within the specified range, the mobile terminal which is incapable of communicating with the infrared communications means is not counted as the number of population.

This configuration considers that local area network means such as infrared communications means is usually included in current widely distributed mobile terminals. Local area network means, which allows mobile terminals within a short distance to communicate with each other, is used for population number measurements, which is reflected to the advertising impact as a weight. However, in case the local area network means uses the infrared method, since it is impossible to communicate with a mobile terminal of a man who is blocked by an obstacle that the infrared ray cannot pass, in this case, although the mobile terminal exists in a nearby location, it is preferred that this advertising impact is not acknowledged.

In the meantime, the local area network means may include a wireless communications means able to perceive the number of mobile terminals by communicating with radio waves. In the case of using infrared communication methods, it is difficult to perceive the number of mobile terminals when an obstacle such as a wall exists; therefore, it is possible to accurately perceive the number of other mobile terminals existing in the surroundings of the mobile terminal by using radio frequency.

According to the first aspect of the invention, it is possible to expand the mobile advertisement method to a network type mobile advertisement method. That is, the mobile advertising method according to the first aspect of the invention further comprises a network mobile advertisement step including a first step of confirming whether other mobile or fixed terminals existing within a specified range of the surroundings of the mobile terminal has installed the same mobile advertisement as the mobile advertisement outputting from the mobile terminal or allows the transmission and installation of the same mobile advertisement, in the latter case the same allowed mobile advertisement is installed to the mobile and fixed terminals, by communicating with other mobile and fixed terminal using local area network means; a second step of confirming whether the other mobile or fixed terminals which have installed or allowed the installation of the same mobile advertisements allows a network type mobile advertisement; and a third step of outputting the same mobile advertisements to the outside by other mobile or fixed terminals which allowed the network type mobile advertisement. In this case, if the mobile advertisement is performed, the mobile advertisement is also outputted from other mobile and fixed terminals existing in the surroundings of the mobile terminal, maximizing the advertising impact. Such network type mobile advertisements can be performed not only in a second mobile terminal within the local network means a first mobile terminal, which first performed the mobile advertisement, but also can be successively performed in a third mobile terminal existing in the local area network means of a second mobile terminal.

However, immediate advertisement output has to be guaranteed in order to perform the network type mobile advertisement. Therefore, the task which confirms installation of the same mobile advertisement or the permission to transmit and install the same mobile advertisement at the secondary other tertiary mobile terminal has to precede the network type mobile advertisement output step.

According to the second aspect of the present invention, provided is a mobile advertisement method by making use of a mobile terminal including an advertisement output unit outputting a mobile advertisements made of one or more among media consisted of a taste, a smell, a sound, an image or the combinations of them to the outside, and a noise measuring unit measuring a noise consisted of a smell, a sound, an image or the combinations of them existing within a specified range of the surroundings; and an advertisement relay server which collects the mobile advertisements from an advertiser's terminal to manage with a member information, the mobile advertisement method comprising: an advertisement setting step of transmitting the mobile advertisements to the mobile terminal and managing a transmission list by the advertisement relay server, and deciding an output condition of the transmitted mobile advertisements; an advertisements execution step of outputting the mobile advertisements to the outside through the advertisement output unit by the mobile terminal, when the output condition is satisfied; a noise measuring step of measuring the noise of the surroundings of a mobile terminal by using the noise measuring unit when the mobile advertisements is outputted to the outside; and an advertisement result managing step of computing and managing an advertisement result classified by members who performed the advertisements execution step, after the advertisement relay server receives the measured noise, and changes it into a weight.

This configuration considers the noise of the mobile terminal surroundings as an important advertisement environment that needs to be reflected into the advertising impact in the constantly changing advertisement environment when a mobile advertisement is performed in the mobile terminal. The present invention handles the various advertisement media consisting of a taste, a smell, a sound, an image or the combinations, and thus “the noise” which obstructs the advertising effect also can be a various form composed of a taste, a smell, a sound, an image or the combinations; therefore, the noise measuring unit measuring the noise should be implemented to be suitable for each media as illustrated.

According to a third aspect of the present invention, provided is a mobile advertisement method by making use of a mobile terminal including an advertisement output unit outputting a mobile advertisements made of one or more among media consisted of a taste, a smell, a sound, an image or the combinations of them to the outside; a support server which stores and manages a setting information on a population number existing within a specified range of the surroundings use of the mobile terminal, or a noise consisted of a smell, a sound, an image or the combinations of them according to the location of the mobile terminal; and an advertisement relay server which collects the mobile advertisements from an advertiser's terminal to manage with a member information, the mobile advertisement method comprising: an advertisements setting step of transmitting the mobile advertisements to the mobile terminal and managing a transmission list, and deciding an output condition of the transmitted mobile advertisements by the advertisement relay server; an advertisements execution step of outputting the mobile advertisements to the outside through the advertisement output unit by the mobile terminal, when the output condition is satisfied; a setting information transmitting step of transmitting the setting information according to the location of the mobile terminal when the support server perceives that the advertisements execution step is performed; and an advertisement result managing step of computing and managing an advertisement result classified by members who performed the advertisements execution step, after the advertisement relay server receives the setting information, and changes it into a weight.

The mobile advertisement method according to the first aspect and the second aspect of the present invention uses a weight to be reflected on the advertising impact in the mobile terminal side as the number of population or the noise, whereas the mobile advertisement method according to the third aspect of the present invention uses a support server which traces the location of the mobile terminal, stores and manages the setup information for the number of population existing within the specified range of the mobile terminal surroundings according to the location of the mobile terminal, or the noise consisting of a smell, a sound, and an image or these combinations.

When the support server is used, it has an advantage in that an additional configuration for measuring the number of population or the noise in the mobile terminal is not necessary, and in this case, for example, the support server altogether sets up the noise and the number of population with a high value for Gang-nam station of Seoul, so that it is possible that the noise weight of the Gang-nam station can be applied with 0.5, and the number of population weight can be applied with 2.0 when the advertisement relay server evaluates the advertising impact.

According to a fourth aspect of the present invention, provided is a mobile advertisement method by making use of a mobile terminal including an advertisement output unit outputting a mobile advertisement made of one or more among media consisted of a taste, a smell, a sound, an image or the combinations of them to the outside; a support server which measures and manages a population number existing within a specified range of the surroundings of the mobile terminal according to the location of the mobile terminal; and an advertisement relay server which collects the mobile advertisements from an advertiser's terminal to manage with a member information, the mobile advertisement method comprising: an advertisements setting step of transmitting the mobile advertisements to the mobile terminal and managing a transmission list, and deciding an output condition of the transmitted mobile advertisements by the advertisement relay server; an advertisements execution step of outputting the mobile advertisements to the outside through the advertisement output unit by the mobile terminal, when the output condition is satisfied; a population number information transmitting step of transmitting a population number information which is measured according to the location of the mobile terminal when the support server perceives that the advertisements execution step is performed; and an advertisement result managing step of computing and managing an advertisement result classified by members who performed the advertisements execution step, after the advertisement relay server receives the population number information, and changes it into a weight.

The advertisement method according to the fourth aspect of the present invention has a difference in that the support server replaces the population number measurement function of the mobile terminal in comparison with the advertisement method according to the first aspect of the present invention. That is, in case of the advertisement method according to the first aspect of the present invention, the mobile terminal includes the population number measuring unit to measure the population number of surroundings when the mobile advertisement is performed. On the other hand, in the advertisement method according to the third aspect of the present invention, the support server is able to measure the number of population to reflect on the advertising impact although such population number measuring unit is not set up in the mobile terminal. In the meantime, in case a noise measurement unit, which can wirelessly transmit and receive the information with the support server are located in the surroundings, it is naturally possible that the support server not only measures the number of population but also measures the noise which exists according to the location of the mobile terminal. If the support server can support the noise measuring, then, the devices for noise measuring such as a microphone, an optical sensor, and a particle extractor need not to be set up in the mobile terminal.

As to the advertisement method according to the fourth aspect of the present invention, it is preferable that the support server includes a base station, which not only traces and manages the location information of the mobile terminal user who joined the mobile communications, but also measures the number of mobile terminals within the specified range as the population number for the mobile terminal. Moreover, preferably, the mobile terminal and support server respectively include GPS means capable of communicating with a satellite, which the support server uses to receive location information of the mobile terminal to measure the number of other mobile terminals as a measurement of population.

According to the fifth aspect of the present invention, provided is a mobile advertisement method by making use of a mobile terminal including an advertisement output unit outputting a mobile advertisements made of one or more among media consisted of a taste, a smell, a sound, an image or the combinations of them to the outside, and a population number measuring unit measuring the number of population existing within a specified range of the surroundings; and an advertisement relay server which collects the mobile advertisements from an advertiser's terminal to manage with a member information, the mobile advertisement method comprising: a population number monitoring step of measuring the population number of the surroundings of the mobile terminal by using the population number measuring unit, and monitoring whether this measured population number exceeds a given value in the mobile terminal side; an advertisements installation step of, in case the measured population number exceeds the given value, performing a compulsive transmission of the mobile advertisements to the mobile terminal by the advertisement relay server, managing the a list of the compulsive transmission, and deciding an output condition of the transmitted mobile advertisements; and an advertisement performing and result managing step of, in case the output condition is satisfied, computing and managing an advertisement result classified by members who admitted the compulsive transmitting by the advertisement relay server, while the mobile terminal outputs the mobile advertisements to the outside through the advertisement output unit.

According to a sixth aspect of the present invention, provided is a mobile advertisement method by making use of a mobile terminal including an advertisement output unit outputting a mobile advertisements made of one or more among media consisted of a taste, a smell, a sound, an image or the combinations of them to the outside, and a noise measuring unit measuring a noise consisted of a smell, a sound, an image or the combinations of them existing within a specified range of the surroundings; and an advertisement relay server which collects the mobile advertisements from an advertiser's terminal to manage with a member information, the mobile advertisement method comprising: a population number monitoring step of measuring the noise of the surroundings of the mobile terminal by using the population noise measuring unit, and monitoring whether the measured noise exceeds a given value, in the mobile terminal side; an advertisements installation step of, in case the measured noise is below the given value, performing a compulsive transmission of the mobile advertisements to the mobile terminal by the advertisement relay server, managing the a list of the compulsive transmission, and deciding an output condition of the transmitted mobile advertisements; and an advertisement performing and result managing step of, in case the output condition is satisfied, computing and managing an advertisement result classified by members who admitted the compulsive transmitting by the advertisement relay server, while the mobile terminal outputs the mobile advertisements to the outside through the advertisement output unit.

As to the mobile advertisement method according to the fifth and the sixth aspect of the present invention, the mobile terminal includes the population number measuring unit to continuously watch the number of population of surroundings or the surrounding noise of the mobile terminal, thereafter, the mobile advertisement is performed only when it is recognized to be suitable for performing the mobile advertisement because the number of population of surroundings exceeds the given value or the surroundings noise is decreased than the given value. In this case, since the mobile terminal does not always need to store the mobile advertisements, the memory burden of the mobile terminal can be reduced.

In the meantime, according to case of a mobile advertisement related to the first to the sixth aspect of the present invention, it is preferable that the advertisement relay server further includes a compensation step of providing one or more of the following: communications fee support, electronic coupon publication, electronic point accumulation and gift provision for the user of the mobile terminal who is a member.

This step offers compensation to the members participating in the mobile advertisement which is performed in the advertisement relay server by using the member's advertising impact information that the advertisement relay server obtained. Through this, user participation for mobile advertisements can be enhanced.

Moreover, in case of the mobile advertisement method according to the first to the sixth aspect of the present invention, it is preferable that the advertisement relay server sets up a different hourly weight according to the time slot when the mobile advertisements is outputted, and reflect this in the calculation of the advertising impact. Even within the same location, because the population number or the noise changes according depending on the time, a more accurate evaluation of the advertising impact will be possible when reflecting the time slot information into calculation of the advertising impact.

In addition, the mobile terminal further includes the output information monitor watching one or more output information among the following: output level of the mobile advertisements by the advertisements output unit, the output number instances of the mobile advertisements, and output time lapse of the mobile advertisements. More preferably, the advertisement relay server receives the output information from the mobile terminal to reflect in the calculation of the advertising impact.

For example, in case of the mobile advertisements consisting of sound media, when the sound volume of the mobile terminal is differently set for each user, the advertising effect output to the surroundings differs. Therefore, through such configuration, it is possible that the advertisement relay server reflects the various terminal conditions dependent on the user settings of the mobile terminal to the advertising impact.

In the meantime, in case of the mobile advertisement method according to the first to the sixth aspect of the present invention, the output condition is the case in which the mobile terminal invokes the call signal. And, even in case the advertisement output unit is set up as a non output state, it may further include the override setting step which sets up the override function for the mobile terminal in order to output the mobile advertisements to the outside by force when the output condition is satisfied.

For example, the sound type mobile advertisement is set to be outputted when the bell rings in the mobile telephone. However, the mobile advertisements cannot be outputted if user sets the mobile telephone to manner mode. In this case, the advertisement relay server can commit an error of acknowledging the advertising impact which is not generated. Therefore, it is preferable that the mobile advertisement is compulsively performed if the user is a member who has given permission to perform override mobile advertisements, so that it is guaranteed that the mobile advertisement to be performed is not omitted.

The mobile advertisement method according to the first to the sixth aspect of the present invention can be implemented with a mobile terminal for the mobile advertisement and a mobile advertisement system.

That is, according to the present invention, the mobile terminal for mobile advertisement comprises a storage which stores a mobile advertisements made of one or more among media consisted of a taste, a smell, a sound, an image or the combinations of them; an advertisement output unit which outputs the mobile advertisements to the outside according to a given output condition; a population number measuring unit which measures the number of population existing within a specified range of the surroundings; a wireless transceiver which communicates with an advertisement relay server which collects the mobile advertisements from an advertiser's terminal to manage together with member information; and a controller that functions as an overall controller of a device by connecting to the storage, the advertisement output unit, the population number measuring unit, and the wireless transceiver, wherein the controller, when the output condition is satisfied, outputs the mobile advertisements to the outside through the advertisement output unit, and measures the population number of the surroundings of a mobile terminal by using the population number measuring unit when the mobile advertisement is outputted to the outside to transmit the measured value to the advertisement relay server through the wireless transceiver, so that the advertisement relay server receives the measured population number, and changes it into a weight, and computes and manages an advertisement result classified by members who outputted the mobile advertisements.

According to the present invention, the mobile terminal for mobile advertisement also can be comprised of a storage which stores a mobile advertisement made of one or more media consisting of a taste, a smell, a sound, an image or a combination of them; an advertisement output unit which outputs the mobile advertisements to the outside according to a given output condition; a noise measuring unit measuring a noise consisted of a smell, a sound, an image or the combinations of them existing within a specified range of the surroundings; a wireless transceiver which communicates with an advertisement relay server which collects the mobile advertisements from an advertiser's terminal to manage with a member information; and a controller which controls an overall control of a device by connecting to the storage, the advertisement output unit, the noise measuring unit, and the wireless transceiver, wherein the controller, when the output condition is satisfied, outputs the mobile advertisements to the outside through the advertisement output unit, and measures the noise of the surroundings of a mobile terminal by using the noise measuring unit when the mobile advertisements is outputted to the outside to transmit the measured value to the advertisement relay server through the wireless transceiver, so that the advertisement relay server receives the measured noise, and changes it into a weight, and computes and manages an advertisement result classified by members who outputted the mobile advertisements.

According to the present invention, the mobile advertisement system comprises a mobile terminal including an advertisement output unit outputting a mobile advertisements made of one or more among media consisted of a taste, a smell, a sound, an image or the combinations of them to the outside; a support server which stores and manages a setting information on a population number existing within a specified range of the surroundings use of the mobile terminal, or a noise consisted of a smell, a sound, an image or the combinations of them according to the location of the mobile terminal; and an advertisement relay server which collects the mobile advertisements from an advertiser's terminal to manage with a member information, wherein the advertisement relay server transmits the mobile advertisements to the mobile terminal and manages a transmission list, and decides an output condition of the transmitted mobile advertisements, wherein the mobile terminal outputs the mobile advertisements to the outside through the advertisement output unit, when the output condition is satisfied, wherein the support server transmits the setting information according to the location of the mobile terminal when the mobile advertisements is outputted, wherein the advertisement relay server receives the setting information and changes it into a weight to compute and manage an advertisement result classified by members who outputted the mobile advertisements.

According to the present invention, the mobile advertisement system also can be comprised of a mobile terminal including an advertisement output unit outputting a mobile advertisements made of one or more among media consisted of a taste, a smell, a sound, an image or the combinations of them to the outside; a support server which measures and manages a population number existing within a specified range of the surroundings use of the mobile terminal according to the location of the mobile terminal; and an advertisement relay server which collects the mobile advertisements from an advertiser's terminal to manage with a member information, wherein the advertisement relay server transmits the mobile advertisements to the mobile terminal and manages a transmission list, and decides an output condition of the transmitted mobile advertisements, wherein the mobile terminal outputs the mobile advertisements to the outside through the advertisement output unit, when the output condition is satisfied, wherein the support server transmits the population number information which is measured according to the location of the mobile terminal when the mobile advertisements is outputted, wherein the advertisement relay server receives the population number information and changes it into a weight to compute and manage an advertisement result classified by members who outputted the mobile advertisements.

According to the present invention, the mobile terminal also can be comprised of a storage which stores a mobile advertisements made of one or more among media consisted of a taste, a smell, a sound, an image or the combinations of them; an advertisement output unit which outputs the mobile advertisements to the outside according to a given output condition; a population number measuring unit which measures the number of population existing within a specified range of the surroundings; a wireless transceiver which communicates with an advertisement relay server which collects the mobile advertisements from an advertiser's terminal to manage with a member information; and a controller which controls an overall control of a device by connecting to the storage, the advertisement output unit, the population number measuring unit, and the wireless transceiver, wherein the controller measures the population number of the surroundings of the mobile terminal by using the population number measuring unit, and monitors whether the measured population number exceeds a given value, while in case the measured population number exceeds the given value, compulsively receiving the mobile advertisements from the advertisement relay server, and, in case the output condition is satisfied, outputting the mobile advertisements to the outside through the advertisement output unit and transmits an output list of the mobile advertisements to the advertisement relay server, so that the advertisement relay server is able to compute and manage an advertisement result classified by members who admitted the compulsive transmitting.

According to the present invention, the mobile terminal also can be comprised of a storage which stores a mobile advertisement made of one or more among media consisted of a taste, a smell, a sound, an image or a combination of them; an advertisement output unit which outputs the mobile advertisements to the outside according to a given output condition; a noise measuring unit measuring a noise consisted of a smell, a sound, an image or the combinations of them existing within a specified range of the surroundings; a wireless transceiver which communicates with an advertisement relay server which collects the mobile advertisements from an advertiser's terminal to manage with a member information; and a controller which controls an overall control of a device by connecting to the storage, the advertisement output unit, the noise measuring unit, and the wireless transceiver,

wherein the controller measures the noise of the surroundings of the mobile terminal by using the noise measuring unit, and monitors whether the measured noise exceeds a given value, while in case the measured noise exceeds the given value, compulsively receiving the mobile advertisements from the advertisement relay server, and, in case the output condition is satisfied, outputting the mobile advertisements to the outside through the advertisement output unit and transmit the output list of the mobile advertisements to the advertisement relay server, so that the advertisement relay server is able to compute and manage an advertisement result classified by members who admitted the compulsive transmitting.

According to the present invention, the mobile terminal also can be comprised of a storage which stores a mobile advertisement made of one or more among media consisted of a taste, a smell, a sound, an image or a combination of them; an advertisement output unit which outputs the mobile advertisements to the outside according to a given output condition; a population measuring unit and or noise measuring unit measuring a noise consisted of a smell, a sound, an image or the combinations of them existing within a specified range of the surroundings; a wireless transceiver which communicates with an advertisement relay server which collects the mobile advertisements from an advertiser's terminal to manage with a member information; and a controller which controls an overall control of a device by connecting to the storage, the advertisement output unit, the population measurement unit, the noise measuring unit, and the wireless transceiver, wherein the controller measures the population number of the mobile terminal by using the population measuring unit, wherein the controller measures the noise of the surroundings of the mobile terminal by using the noise measuring unit, where mobile terminal 100 measures the population number and measures mobile terminal 100′ and mobile terminal 100″; where mobile terminal 100 confirms the advertising medium of mobile terminal of 100′ and mobile terminal 100″; where mobile terminal 100 may or may not compulsively transmit advertising medium to mobile terminals 100′ and mobile terminal 100″; in the case that mobile terminal 100 confirms that mobile terminal 100′ and mobile terminal 100″ have the same advertising medium set, any of the mobile terminals 100, 100′ and 100″ output the advertising medium together; in the case that mobile terminal 100 has different advertising medium from mobile terminal 100′ and mobile terminal 100″; the different advertising medium can be played collectively in intervals or in unison; and, in case the output condition is satisfied, outputting the mobile advertisements to the outside through the advertisement output unit and transmit the output list of the mobile advertisements to the advertisement relay server, so that the advertisement relay server is able to compute and manage an advertisement result classified by members.

According to the present invention, the mobile terminal also can be comprised of a storage which stores a mobile advertisement made of one or more among media consisted of a taste, a smell, a sound, an image or a combination of them; an advertisement output unit which outputs the mobile advertisements to the outside according to a given output condition; a population measuring unit and or noise measuring unit measuring a noise consisted of a smell, a sound, an image or the combinations of them existing within a specified range of the surroundings; a wireless transceiver which communicates with an advertisement relay server which collects the mobile advertisements from an advertiser's terminal to manage with a member information; and a controller which controls an overall control of a device by connecting to the storage, the advertisement output unit, the population measurement unit, the noise measuring unit, and the wireless transceiver, wherein the controller measures the population number of the mobile terminal by using the population measuring unit, wherein the controller measures the noise of the surroundings of the mobile terminal by using the noise measuring unit, where mobile terminal 100 user A measures mobile terminal 100′ user B and mobile terminal 100″ user C during population measurement; where it is determined that user B and user C have been exposed to the mobile advertisement outputted by user A within a specified noise range; where user B and user C are recorded in the population measurement data of user A to the advertisement relay server; where user B and user C are determined to have purchased a product based on the advertisement outputted by user A by comparing user A's advertising database and user B's and user C's purchase database; and, in case the output condition is satisfied, outputting the mobile advertisements to the outside through the advertisement output unit and transmit the output list of the mobile advertisements to the advertisement relay server, so that the advertisement relay server is able to compute and manage an advertisement result classified by members.

### Advantageous Effects

As described above, the present invention relates to the mobile advertisement method making use of the mobile terminal and the advertisement relay server, suggesting the mobile advertisement method considering the point that the environmental variables such as population number or the noise of the surroundings alter constantly when the mobile advertisement is outputted from the mobile terminal.

As described, the present invention relates to the mobile advertisement using the mobile terminal, while considering the point that the situation where this mobile advertisement is performed can change constantly. Provided is the mobile advertisement method using the mobile terminal which is suitable for the special situation that is a mobile advertisement. Accordingly, the advertisement results can be properly evaluated and managed for the user of the mobile terminal that operates the mobile advertisement. Through this, not only the participation of users but also the participation of advertisers for mobile advertisements will increase.

### BRIEF DESCRIPTION OF THE DRAWINGS

FIG. 1 is a drawing showing the configuration of a mobile terminal capable of performing the mobile advertisement and mobile advertisement method according to the present invention.

FIG. 2 is a drawing showing the mobile advertisement system according to the present invention.

FIG. 3 is a drawing showing the network type mobile advertisement case according to the present invention.

FIG. 4 is a flowchart showing the first embodiment of the mobile advertisement method according to the present invention.

FIG. 5 is flowchart showing the second embodiment of the mobile advertisement method according to the present invention.

FIG. 6 is a flowchart showing the third embodiment of the mobile advertisement method according to the present invention.

### BEST MODE FOR CARRYING OUT THE INVENTION

Hereinafter, preferred embodiments of the present invention will be illustrated with reference to the attached drawings.

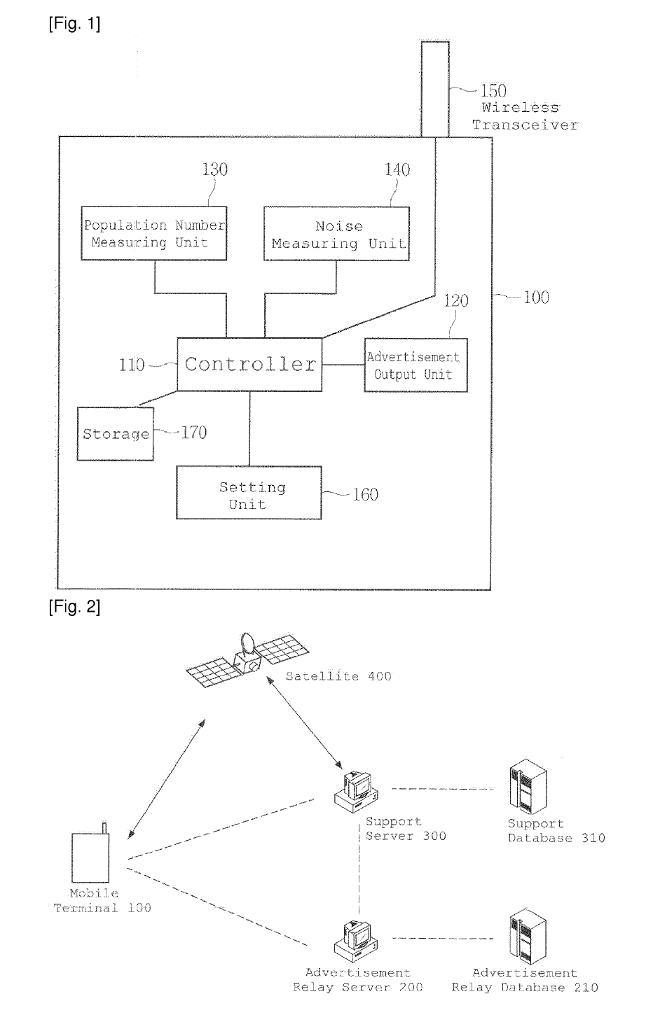

FIG. 1 is a drawing showing a mobile terminal capable of performing the mobile advertisement method according to the present invention, and FIG. 2 is a drawing showing the mobile advertisement system according to the present invention.

Firstly, referring to FIG. 1, a mobile terminal 100 of the present invention includes a controller 110 that performs the overall apparatus control. The controller 110 is connected to an advertisement output unit 120 that outputs a media consisting of a taste, a smell, a sound, an image or a combination of them. For reference, the term terminal in the present disclosure means any type of terminal that supports wire or wireless communication technology such as a PC, cellular phone, PDA (Personal Digital Assistance) and so on.

The mobile advertisements relating to the present invention have the form of media consisting of a taste, a smell, a sound, an image or a combination of them. An advertisement relay server 200 shown in FIG. 2 receives the mobile advertisements from the advertiser's terminal (not shown), while it is stored and managed in an advertisement relay database 210. In addition, when the user of the mobile terminal 100 requests or the contents of the mobile advertisements is arbitrarily transmitted from the advertisement relay server 200 to the mobile terminal 100 through a wireless transceiver 150 of the mobile terminal 100, it is also stored and managed in a storage 170 of the mobile terminal 100. Here, it should be noted that the advertisement relay database 210 may include not only the mobile advertisements but also the information obtained by user analysis. That is, the advertisement relay server 200 may automatically link or recommend mobile advertisement to users based on the analyzed user information stored in the advertisement relay database 210. Also, the user analysis may include the analysis of user's preferences on the various mobile advertisements, which may be helpful for the advertisement relay server 200 to recommend a desirable mobile advertisement for a specific user based on his or her preference analysis.

In the meantime, the configuration of the advertisement output unit 120 can be changed according to the form of mobile advertisements; it can be comprised of a speaker outputting the sound, and an LCD outputting an image. In addition, it can be comprised of a particle emitter ejecting particles to the outside, which can stimulate the sense of taste or the sense of smell based on data about the state of particle combination. Additionally, the output state of the sound or image, or particles of the advertisement output unit 120 is under the control of the controller 110 and a setting unit 160, which receives external input of user.

In case the advertisement output unit 120 outputs the mobile advertisements, the controller 110 has to watch one or more output information including the output level, the output number and the output time of the mobile advertisements. The values of such output information are transmitted to the advertisement relay server 200 and they are reflected in the calculation of the advertisement results. This output information monitoring operation that the controller 110 performs is possible to be implemented with an additional configuration as an output information monitor unit (not shown). Additionally, the controller 110 controls the operation of a population number measuring unit 130 and a noise measuring unit 140. The population number measuring unit 130 can be comprised of any local area network communications device, for example infrared communications means. In the present invention, the population number means the number of surrounding population who are exposed to the mobile advertisements, and it is possible that the population number can be determined as the number of mobile terminals on the assumption that one person holds one mobile terminal. The population number plays the role of a positive factor in the evaluation of the advertisement results which will be described later.

In the meantime, the noise measuring unit 140 can be made of various types like the advertisement output unit 120 which is described above according to the medium type of the mobile advertisements. For example, when the mobile advertisements is a sound or an image, the noise measuring unit 140 can be comprised of a microphone capable of measuring the external noise or an optical sensor capable of measuring the external quantity of light. These are factors which are evaluated as an element that lowers the advertising impact of the mobile advertisements which are to be exposed to the surrounding population of the mobile terminal.

FIG. 2 shows a mobile advertisement system 500 according to an embodiment of the present invention. As described above, the advertisement relay server 200 is a configuration which stores and manages and the mobile advertisements and member information through the advertisement relay database 210, after receiving the mobile advertisements from the advertiser's terminal (not shown). The advertisement relay server 200 provides a website and, through this, can recruit members who would participate in mobile advertisement.

A support server 300 is a configuration for replacing the measurement function of the mobile advertisement environment, which the population number measuring unit 130 or the noise measuring unit 140 also manage, for mobile terminal 100. The location of mobile terminal 100 is traced through the wireless transceiver 150 of the mobile terminal 100. Values are set up in advance according to a corresponding location for the number of population or the surroundings noise to be managed in a support data base 310. In addition, the support server 300 can measure the information for the location of the mobile terminal 100 and the population number through communicating with a satellite 400. A base station (not shown), GPS, and wireless network connectivity can also be used to determine and manage the location of mobile terminal 100.

In the configuration of FIG. 2, the advertisement relay server 200 and the support server 300 were physically separated. However, it is also possible that the advertisement relay provider who manages the mobile advertisement enterprise operates these two servers as one server.

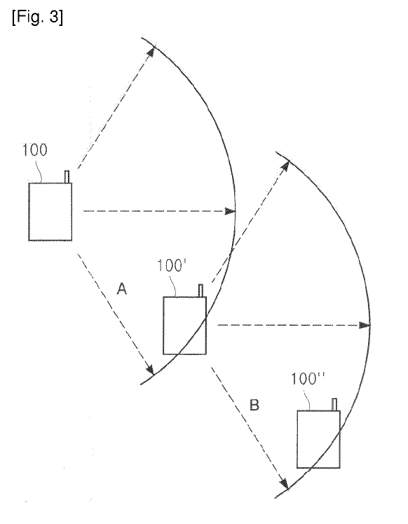

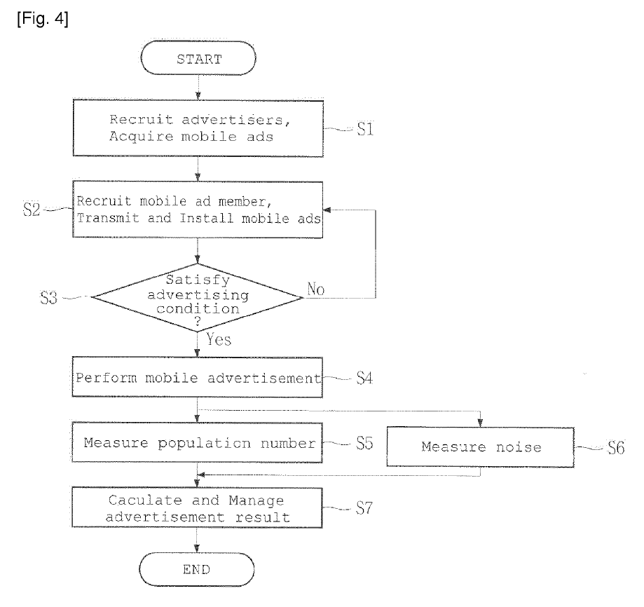

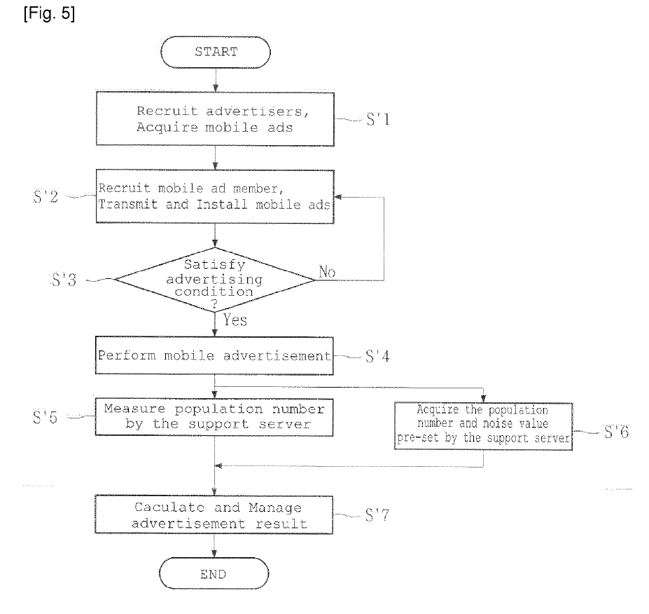

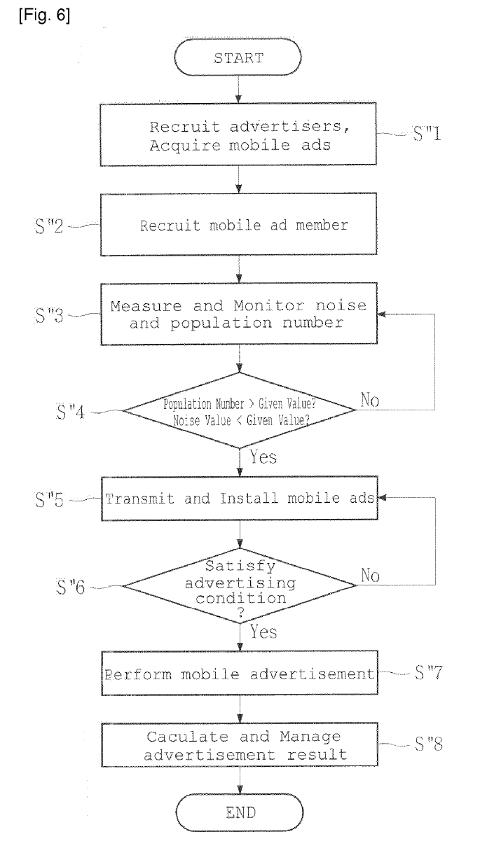

In the meantime, FIG. 3 is a drawing showing the case where a network type mobile advertisement is performed. FIG. 4 is a flowchart showing the first embodiment of the mobile advertisement method according to the present invention, FIG. 5 is a flowchart showing the second embodiment of the mobile advertisement method according to the present invention, and FIG. 6 is a flowchart showing the third embodiment of the mobile advertisement method according to the present invention.

Now, referring to FIGS. 1 to 6, preferable embodiments of the present invention will be illustrated in detail.

### First Embodiment

Referring to FIG. 4, the advertisement relay server 200 recruits an advertiser through a website, for instance, a website that is operated by that same relay server 200 (step S1). In this case, the advertiser's terminal (not shown) becomes a member of the website and the advertisement relay server 200 operates as advertiser member and registers mobile advertisements which will be used for mobile advertisement.

Then, the advertisement relay server 200 recruits normal members who would participate in the mobile advertisement through the advertisement relay website and transmits the mobile advertisement to the collected member to install the mobile advertisement. (step S2).

Here, the normal member is a person who holds mobile terminals 100, 100′, 100″, performing a role as an advertisement agent by outputting the mobile advertisements which is downloaded from the advertisement relay server 200 according to a given condition. The transmission and the installation of the mobile advertisements can be performed in the type of PULL with the request of the user of the mobile terminal 100. On the other hand, in order to perform a simple installation and an update of the mobile advertisements, although there is no request of a user, the advertisement relay server 200 can perform a PUSH type transmission of the mobile advertisements to the mobile terminal 100.

When the mobile advertisement is installed at the storage 170 of the mobile terminal 100, the controller 110 of the mobile terminal 100 confirms whether the determined advertising condition between the advertisement relay server 200 and the member is satisfied (step S3). Here, the advertising condition means a mobile advertisements output condition, for instance, in case that the mobile-phone receives an incoming call signal, an advertisement bell sound or an image advertisement according to the mobile advertisement is outputted. The details may be set up in advance by the advertisement relay server 200. However, the details can also be decided between the advertisement relay server 200 and the user (member) of the mobile terminal 100. The data on the advertising condition is stored and managed in the storage 170 of the mobile terminal 100 and the advertisement relay database 210 of advertisement relay server 200.

When the advertising condition is not satisfied (when it is “NO” in the step S3), it returns to the step S2 and waits for the advertising condition to be satisfied. When the advertising condition is satisfied (when it is “YES” in step S3), it proceeds to step S4 to perform the mobile advertisement. As described above, the execution of the mobile advertisement is made through the controller 110 and the advertisement output unit 140. In the case of a sound or image advertisement, the controller 110 loads the sound source or the image which is stored in the storage 170 into the advertisement output unit 140 to output the sound or the image to the outside through a digital analogue converting means. Moreover, in the case it is an olfactory or gustatory advertisement, based on the indication of the controller 110, the appropriate combination of particles is obtained by opening or closing the appropriate particle channel, which is outputted by the advertisement output unit 120. The olfactory, gustatory aural and visual advertisements and the combination of the above are possible, and such combinations have an advertisement characteristic that make surroundings persons who are exposed to an advertisement relate with a specific product or an advertiser.

When the mobile advertisement is performed, the number of the surrounding population is measured by using the population number measuring unit 130 in the mobile terminal 100 side (step S5), and the noise of neighboring of the mobile terminal 100 is measured by using the noise measuring unit 140 (step S6). In FIG. 4, it is shown that step S5 and step S6 were simultaneously performed. However, after the mobile advertisement is performed, it is acceptable that just only the number of population or the noise is measured, or it is acceptable that the number of population and the noise are simultaneously measured, or sequentially measured. The first embodiment considers the population number value or the noise value measured by the mobile terminal 100 in evaluating the advertising effect of the performed mobile advertisements. Therefore, it should be noted that the execution of step S5 or step S6 has to be made according to the medium type of the mobile advertisements.

When the step S5 and the step S6 are simultaneously or sequentially performed, it is preferable that the noise measuring is firstly performed and the range which measures the number of population is separately determined according to the level of the measured noise.

For example, in case the default range measuring the population number is 10 m, when noise is detected along with the fact that a severely bad smell exists in the location of the surroundings of the mobile terminal, the surrounding persons exposed to advertisements related to smell or taste are unable to perceive smell or taste. Therefore, the advertising effectiveness is only admitted for the persons who are located within a 0.5 m radius, and for example the number of neighboring population can be measured with an infrared communications means. For reference, “a specified range” measuring the number of population needs not to be the circular type. The specified range can be two-dimensional or three-dimensional. For instance, in case a wall which is unable to pass the infra-red signal exists, an arbitrary square form can be adopted. No matter how a man is located near the mobile terminal 100 in which the mobile advertisement is performed, when the advertisements of a sound, a smell, or an image cannot be seen, because a wall exists between the users of the mobile terminal 100, it is not counted as the number of population in the step S5.

But, in the case of not using infrared ray but using radio frequency (RF) as a local area network means, although an obstacle like the wall exists between the user of the mobile terminal 100 and the user of other mobile terminal, a communication between mobile terminals is possible, and the population number can be counted.

Then, after the number of neighboring population and noise of the mobile terminal at the time when the mobile advertisement was performed is measured, the controller 110 transmits the value to the advertisement relay server 200 through the wireless transceiver 150, while the advertisement relay server 200 converts the measured value of the noise and population number to a weighted value to compute and manage the advertising impact (step S7).

For example, in case 100 points are given for every mobile advertisement execution of a sound type, when the population number measuring unit 130 made of the infrared communications means measures 15 people which are 5 more than 10 people which is a reference value, while the noise measuring unit 140 measures 20 dB which is two times 10 dB which is a reference value, the advertising impact can be computed as 100*1.5 (population number measured value reflection portion)*0.5 (noise measuring value reflection portion)=75 points.

The advertising impact of 75 points is managed under the control of the advertisement relay database 210 according to the member, and it is used when the advertisement relay server 200 compensates the member in the form of communications fee discount, electronic coupon publication, electronics point accumulation or gift provision according to the advertising impact. In the step S7, the advertisement relay server 200 confirms the time information of the mobile advertisement, so that the advertising impact can be computed by assigning the weight according to the time when the mobile advertisements is outputted.

For example, at A.M. 4 which is a certain time when the user of the mobile terminal 100, although the smell for advertisement is outputted, the weight 0.0 is multiplied so that an advertisement to the user oneself is not reflected as an advertising impact, while, at P.M. 2 when a user in the office is working hard and is more likely to have a measured population number, the weight 1.1 can be multiplied.

In the mean time, although not shown in FIG. 4, in the process of step 4 to step 7, the controller 110 of the mobile terminal 100 or an output information monitoring unit (not shown) collects the advertisements output information such as the number of output, the level of output, or the time of output of mobile advertisements outputted by the advertisement output unit 120, and transmits the information to the advertisement relay server 200, while the advertisement relay server 200 is able to calculate the advertising impact based on the received advertisements output information.

For example, suppose that a default weight is applied when the mobile advertisements of the sound type is outputted with the sound volume 20 for 10 seconds. Then, when the mobile advertisements of the sound type is outputted with the sound volume 40 for 20 seconds, the advertising impact can be computed by reflecting the weight 4.0, which is the weighted value of 2.0*2.0.

In addition, although not shown in FIG. 4, in the step S4 and in the step S7, the following problems can arise. That is, suppose that the mobile advertisements is a visual type advertisements of the laser form (in other words, an image advertisement) which is emitted through the advertisement output unit 120 of the mobile terminal 100, when the user sets up a condition that the laser is not emitted even when the bell rings through the setting unit 160, the situation where although the advertising condition of ringing of a bell is satisfied, step S4 not being performed can arise.

Preparing for such situation, in step S2 where the advertisement relay server 200 transmits the mobile advertisements to the mobile terminal 100, it is preferable that the override function is installed in the controller 110 of mobile terminal 100. The override function means that a certain operation is compulsively performed or not performed while ignoring the user setting when a given condition is satisfied although the user of the mobile terminal arbitrarily controls the operation state of a device. The mobile advertisement can be reliably performed by applying this override function to step S4 of the mobile advertisement method of the present invention. On the contrary, it is possible that step S4 is performed only when it is not the case where the mobile advertisement is not outputted with the override function.

In the meantime, in case the population number measuring unit 130 of the mobile terminal 100 includes a local area network means, it is preferable that the step S4 further includes a network type advertisement operation step. The network type advertisement means a state, as shown in FIG. 3, where another mobile terminal 100′ which exists within a specified range (radius A) of the mobile terminal 100 which outputs the mobile advertisement set up the mobile advertisements which is may or may not be identical with the mobile advertisements presently outputted. When the local area network means perceives another mobile terminal 100′ in which the advertising condition is not yet satisfied, also outputs the mobile advertisements.

Such a network type mobile advertisement is a technique which maximizes the advertisement range of the mobile advertisement, and it is possible to implement a consecutive network type mobile advertisement in which the advertisement is executed again by the mobile terminal 100′ for other mobile terminal 100″ belonging to the radius B. In this case, the advertising impact reaches the range exceeding the radius A+B, so that the user of the mobile terminal 100 can obtain much greater advertisement results than the normal non-network type mobile advertisement.

It is also possible for the network type advertisement to use two different advertisements in terminal 100 and 100. For example, terminal 100 and 100 can play different sound notes to compose music or they can shoot different laser colors to create an image together.

### Second Embodiment

FIG. 5 shows the mobile advertisement method according to the second embodiment of the present invention.

The second embodiment of the present invention has a difference in step S′5 to step S′7 in comparison with the first embodiment. Therefore, the description of step S′1 to step S′4 is replaced with the corresponding description of step S1 to step S4 of the first embodiment.

In the second embodiment of the present invention, after the mobile advertisement is performed (step S′4), the environmental elements of the surroundings in which the mobile advertisement is performed are not measured in the mobile terminal 100 side, but the advertising impact is computed by the population number and the noise value measured or setup by the support server 300.

In the step S′5, the support server 300 measures the number of population, while the support server 300 measures the number of neighboring population of the mobile terminal performing step S′4 so that the advertisement relay server 200 reflects the number of population to the advertising impact with the weight 5. When the wireless transceiver 150 of the mobile terminal 100 includes GPS, the distribution state of the mobile terminal 100 can be monitored by the satellite 400. Therefore, the support server 300 can measure the number of population existing in a specified range of the surroundings of mobile terminal 100 by communicating with the satellite 400 through GPS means (not shown). Furthermore, when the support server 300 includes the base station (not shown), it is possible that the support server 300 measures the number of population of the surroundings of the mobile terminal which performed the step S′4 by using the location information and the number of population information of the mobile terminal 100 perceived by the base station (not shown). As to the number of population, it may be acceptable that the number of population is set up in advance in the support server 300 according to the location as described in the step S′6, while matching the present location of the mobile terminal 100 performing the step S′4 with the number of population to transmit the value to the advertisement relay server 200.

For example, the number of population of the surroundings of the Cheju Island is set up as the default value 10, while the number of population of the surroundings of Seoul is set up as the default value 100. In that way, the weight which is ten times in comparison with the member who performed the mobile advertisement in the Cheju Island can be given to the member who performed the mobile advertisement in Seoul.

In the step S′6, the support server 300 may set up the noise value of the surroundings of the mobile terminal 100 according to the location in advance besides the number of population. For example, the average noise value of the Seoul Kyong-gi region is set up as 100, while the noise value of the Kimpo region in which an airport is located is set up as 150. In that way, only the ⅔ weight is given for the member who performed the mobile advertisement in the Kimpo region than the other Kyong-gi region.

In FIG. 5, it is shown that step S′5 and step S′6 are simultaneously performed. However, step S′S and step S′6 can be alternatively performed. They can be performed simultaneously or sequentially.

In step S′7, the advertisement relay server 200 receives the execution notification of the mobile advertisement from the mobile terminal 100, and receives the measured value or the set value of the number of population or the noise from the support server 300, thereby, computing and managing the advertising impact. Of course, like step S7, it is desirable for the activation of the mobile advertisement to include the step of compensation performing a predetermined compensation to the member according to the advertising impact.

### Third Embodiment

FIG. 6 shows the mobile advertisement method according to a third embodiment of the present invention.

Firstly, in step S″1, the advertisement relay server 200 recruits an advertiser by using a website, and secures the mobile advertisements to store and manage in the advertisement relay database 210. Then, in step S″2, for example, by using the advertisement relay website, the advertisement relay server 200 recruits the mobile terminal user who would participate in the mobile advertisement as a member. At this time, in contrast to step S2 or S′2, the mobile advertisement is not transmitted or installed in the mobile terminal 100.

Now, the controller 110 of the mobile terminal 100 of the mobile advertisement member drives the population number measuring unit 130 or the noise measuring unit 140 based on the indication received from the advertisement relay server 200 to continuously measure and monitor the number of the surroundings population or the surroundings noise of the mobile terminal 100 (step S″3). In case the number of the surroundings population of the mobile terminal 100 is greater than a given value or the surroundings noise is smaller than a given value (when it is “YES” in the step S″4), it proceeds to the step S″5 where the advertisement relay server 200 transmits and sets up the mobile advertisements to the mobile terminal 100.

That is, in the third embodiment of the present invention, even if one joins in the mobile advertisement member, it does not immediately set up the mobile advertisements, but the mobile advertisements is transmitted to the mobile terminal 100 only when the mobile advertisement environment is admitted to be good enough to set up the mobile advertisements in the mobile terminal 100, so that the memory resource of the mobile terminal 100 can be saved and the advertising effect can be maximized as well as minimize excessive waste costs for advertisers.

After the mobile advertisement is installed at the mobile terminal 100, it proceeds to the step S″6 where the controller 110 of the mobile terminal 100 confirms whether a given advertising condition is satisfied. In case the given advertising condition is satisfied (when it is “YES” in the step 5″6), the mobile advertisement is performed (step S″7) and the advertising impact is computed and managed in the advertisement relay server 200 (step S″8). For reference, step S″6 may be performed between step S″3 and step S″4.

It will be apparent to those skilled in the art that various modifications and variation can be made in the present invention without departing from the spirit or scope of the invention.

For example, a plurality of servers or databases in the present invention may be implemented in a physically separate type or physically integrated type although FIG. 2 of the present invention only deals with the case that the advertisement relay server 200 and the support server 300 are physically separately implemented.

In addition, the present invention may be also applied using the SMS (Short Messaging Service) technique. That is, if a user cannot use the wireless internet communication, the user may send SMS message to notify the advertisement relay server 200 of his or her advertising activity, which is performed the advertising ideas given in the present disclosure. In this case, for example, the advertisement relay server 200 may reward the user who sent SMS message to participate in advertising activity of the present invention by reducing mobile communication service fee.

Since the terminal in the present invention includes both wire and wireless communication terminals, it is also possible to combine the mobile advertisement method according to the present invention with wire communication terminal. For example, when a cellular phone user passes by a PC shop or TV shop and the cellular phone receives an advertisement with image type or moving picture type, the advertisement can be executed not merely on the cellular phone itself, but through an extension of the network type advertisement, can also be executed on the wire communication terminals such as PC's or TV's right beside the cellular phone user. Mobile terminal 100 can transmit the advertising message to the PC 100 or TV 100 terminals for a network type advertisement. This advertising concept may be applied to an outdoor advertising combined with the mobile advertisement method according to the present invention. In this case, digital outdoor screens on buildings may be utilized to output the mobile advertisements handed over by the mobile terminal users around the buildings.

Moreover, it should be noted that the advertisement result obtained by executing the mobile advertisement method according to the present invention does not have to be calculated by a fixed fee rate. For example, assuming that a mobile terminal 100 user A executed a pizza advertisement and another mobile terminal user B was not only exposed to that pizza advertisement but was also monitored to have bought the pizza product, which for example can be confirmed by comparing the database of the exposed population for user A with the purchase database of user B, then the user A may be acknowledged to have made a greater advertisement result than mere exposure and thus be given more advertisement rewards. In this case, the user B may also get an advertisement reward for participating in the advertising activity based on the present invention. For reference, the method to find out whether the user B went to the pizza shop due to the advertising of the user A or not may include a method in which the advertisement relay server identifies the advertising time of the user A and purchasing time of the user B based on the settlement information such as credit card information and accepts the increased advertisement result of the user A only when the time difference between the user A′s advertising activity and the user B′s purchasing activity falls into a predetermined range of time value.

Thus, it is intended that the present invention covers the modifications and variations of this invention provided they come within the scope of the appended claims and their equivalents.

1. A mobile advertisement method by making use of a mobile terminal including an advertisement output unit outputting a mobile advertisements made of one or more among media consisted of a taste, a smell, a sound, an image or the combinations of them to the outside, and a population number measuring unit measuring the number of population existing within a specified range of the surroundings; and an advertisement relay server which collects the mobile advertisements from an advertiser's terminal to manage with a member information, the mobile advertisement method comprising:
an advertisements setting step of transmitting the mobile advertisements to the mobile terminal and managing a transmission list by the advertisement relay server, and deciding an output condition of the transmitted mobile advertisements;
an advertisements execution step of outputting the mobile advertisements to the outside through the advertisement output unit by the mobile terminal, when the output condition is satisfied;
a population number measuring step of measuring the number of population of the surroundings of a mobile terminal by using the population number measuring unit when the mobile advertisements is outputted to the outside; and
an advertisement result managing step of computing and managing an advertisement result classified by members who performed the advertisements execution step, after the advertisement relay server receives the measured population number, and changes it into a weight.

2. A mobile advertisement method by making use of a mobile terminal including an advertisement output unit outputting a mobile advertisements made of one or more among media consisted of a taste, a smell, a sound, an image or the combinations of them to the outside, and a noise measuring unit measuring a noise consisted of a smell, a sound, an image or the combinations of them existing within a specified range of the surroundings; and an advertisement relay server which collects the mobile advertisements from an advertiser's terminal to manage with a member information, the mobile advertisement method comprising:
an advertisements setting step of transmitting the mobile advertisements to the mobile terminal and managing a transmission list by the advertisement relay server, and deciding an output condition of the transmitted mobile advertisements;
an advertisements execution step of outputting the mobile advertisements to the outside through the advertisement output unit by the mobile terminal, when the output condition is satisfied;
a noise measuring step of measuring the noise of the surroundings of a mobile terminal by using the noise measuring unit when the mobile advertisements is outputted to the outside; and
an advertisement result managing step of computing and managing an advertisement result classified by members who performed the advertisements execution step, after the advertisement relay server receives the measured noise, and changes it into a weight.

3. A mobile advertisement method by making use of a mobile terminal including an advertisement output unit outputting a mobile advertisements made of one or more among media consisted of a taste, a smell, a sound, an image or the combinations of them to the outside; a support server which stores and manages a setting information on a population number existing within a specified range of the surroundings use of the mobile terminal, or a noise consisted of a smell, a sound, an image or the combinations of them according to the location of the mobile terminal; and an advertisement relay server which collects the mobile advertisements from an advertiser's terminal to manage with a member information, the mobile advertisement method comprising:
an advertisements setting step of transmitting the mobile advertisements to the mobile terminal and managing a transmission list, and deciding an output condition of the transmitted mobile advertisements by the advertisement relay server;
an advertisements execution step of outputting the mobile advertisements to the outside through the advertisement output unit by the mobile terminal, when the output condition is satisfied;
a setting information transmitting step of transmitting the setting information according to the location of the mobile terminal when the support server perceives that the advertisements execution step is performed; and
an advertisement result managing step of computing and managing an advertisement result classified by members who performed the advertisements execution step, after the advertisement relay server receives the setting information, and changes it into a weight.

4. A mobile advertisement method by making use of a mobile terminal including an advertisement output unit outputting a mobile advertisements made of one or more among media consisted of a taste, a smell, a sound, an image or the combinations of them to the outside; a support server which measures and manages a population number existing within a specified range of the surroundings use of the mobile terminal according to the location of the mobile terminal; and an advertisement relay server which collects the mobile advertisements from an advertiser's terminal to manage with a member information, the mobile advertisement method comprising:
an advertisements setting step of transmitting the mobile advertisements to the mobile terminal and managing a transmission list, and deciding an output condition of the transmitted mobile advertisements by the advertisement relay server;
an advertisements execution step of outputting the mobile advertisements to the outside through the advertisement output unit by the mobile terminal, when the output condition is satisfied;
a population number information transmitting step of transmitting a population number information which is measured according to the location of the mobile terminal when the support server perceives that the advertisements execution step is performed; and
an advertisement result managing step of computing and managing an advertisement result classified by members who performed the advertisements execution step, after the advertisement relay server receives the population number information, and changes it into a weight.

5. A mobile advertisement method by making use of a mobile terminal including an advertisement output unit outputting a mobile advertisements made of one or more among media consisted of a taste, a smell, a sound, an image or the combinations of them to the outside, and a population number measuring unit measuring the number of population existing within a specified range of the surroundings; and an advertisement relay server which collects the mobile advertisements from an advertiser's terminal to manage with a member information, the mobile advertisement method comprising:
a population number monitoring step of measuring the population number of the surroundings of the mobile terminal by using the population number measuring unit, and monitoring whether the measured population number exceeds a given value, in the mobile terminal side;
an advertisements installation step of, in case the measured population number exceeds the given value, performing a compulsive transmitting the mobile advertisements to the mobile terminal by the advertisement relay server, managing the a list of the compulsive transmitting, and deciding an output condition of the transmitted mobile advertisements; and
an advertisement performing and result managing step of, in case the output condition is satisfied, computing and managing an advertisement result classified by members who admitted the compulsive transmitting by the advertisement relay server, while the mobile terminal outputs the mobile advertisements to the outside through the advertisement output unit.

6. A mobile advertisement method by making use of a mobile terminal including an advertisement output unit outputting a mobile advertisements made of one or more among media consisted of a taste, a smell, a sound, an image or the combinations of them to the outside, and a noise measuring unit measuring a noise consisted of a smell, a sound, an image or the combinations of them existing within a specified range of the surroundings; and an advertisement relay server which collects the mobile advertisements from an advertiser's terminal to manage with a member information, the mobile advertisement method comprising:
a population number monitoring step of measuring the noise of the surroundings of the mobile terminal by using the population noise measuring unit, and monitoring whether the measured noise exceeds a given value, in the mobile terminal side;
an advertisements installation step of, in case the measured noise is below the given value, performing a compulsive transmitting the mobile advertisements to the mobile terminal by the advertisement relay server, managing the a list of the compulsive transmitting, and deciding an output condition of the transmitted mobile advertisements; and
an advertisement performing and result managing step of, in case the output condition is satisfied, computing and managing an advertisement result classified by members who admitted the compulsive transmitting by the advertisement relay server, while the mobile terminal outputs the mobile advertisements to the outside through the advertisement output unit.

7. (canceled)

8. The mobile advertisement method of claim 1, wherein the advertisement relay server sets up a different hourly weight according to a time slot when the mobile advertisements is outputted; and reflects it in the calculation of the advertisement result and wherein the mobile terminal further comprises an output information monitoring unit which monitors at least one output information among an output level of outputting the mobile advertisements by the advertisement output unit, an output number of the mobile advertisements, and an output time of the mobile advertisements, wherein the advertisement relay server receives the output information from the mobile terminal to reflect in the calculation of the advertisement result.

9. (canceled)

10. The mobile advertisement method of claim 1, wherein the mobile terminal further comprises a noise measuring unit measuring a noise consisted of a smell, a sound, an image or the combinations of them existing within a specified range of the surroundings, further comprising a noise measuring step of measuring the noise of the surroundings of a mobile terminal by using the noise measuring unit when the mobile advertisements is outputted to the outside, wherein the advertisement relay server receives both the measured noise and the measured population number from the mobile terminal, and changes them into a weight.

11. The mobile advertisement method of claim 10, wherein the specified range that the population number measuring unit measures is differentially set up according to the level of the noise measured in the noise measuring unit.

12-13. (canceled)

14. The mobile advertisement method of claim 1, wherein the population number measuring unit includes a local area network means capable of communicating with other mobile terminal existing within the specified range, while the population number is defined with the number of other mobile terminal measured by the local area network means.

15. The mobile advertisement method of claim 14, wherein the local area network means includes an infrared communications means which is able to determine the number of mobile terminal with an infrared communications, while the mobile terminal does not count other mobile terminal which is incapable of communicating with the infrared communications means as a population number although the other mobile terminal exists within the specified range.

16. The mobile advertisement method of claim 14, further comprising a network mobile advertisement step including
a first step of confirming whether other mobile terminal existing within a specified range of the surroundings of the mobile terminal installs the same mobile advertisements as the mobile advertisements outputting from the mobile terminal, by communicating with other mobile terminal with the local area network means;
a second step of confirming whether the other mobile terminal which installed the same mobile advertisements allows a network type mobile advertisement; and
a third step of outputting the same mobile advertisements to the outside by other mobile terminal which allowed the network type mobile advertisement.

17-19. (canceled)

20. A mobile terminal for mobile advertisement, comprising:
a storage which stores a mobile advertisements made of one or more among media consisted of a taste, a smell, a sound, an image or the combinations of them;
an advertisement output unit which outputs the mobile advertisements to the outside according to a given output condition;
a population number measuring unit which measures the number of population existing within a specified range of the surroundings;
a wireless transceiver which communicates with an advertisement relay server which collects the mobile advertisements from an advertiser's terminal to manage with a member information; and
a controller which controls an overall control of a device by connecting to the storage, the advertisement output unit, the population number measuring unit, and the wireless transceiver,
wherein the controller, when the output condition is satisfied, outputs the mobile advertisements to the outside through the advertisement output unit, and measures the number of population of the surroundings of a mobile terminal by using the population number measuring unit when the mobile advertisements is outputted to the outside to transmit the measured value to the advertisement relay server through the wireless transceiver, so that the advertisement relay server receives the measured population number, and changes it into a weight, and computes and manages an advertisement result classified by members who outputted the mobile advertisements.

21. A mobile terminal for mobile advertisement, comprising:
a storage which stores a mobile advertisements made of one or more among media consisted of a taste, a smell, a sound, an image or the combinations of them;
an advertisement output unit which outputs the mobile advertisements to the outside according to a given output condition;
a noise measuring unit measuring a noise consisted of a smell, a sound, an image or the combinations of them existing within a specified range of the surroundings;
a wireless transceiver which communicates with an advertisement relay server which collects the mobile advertisements from an advertiser's terminal to manage with a member information; and
a controller which controls an overall control of a device by connecting to the storage, the advertisement output unit, the noise measuring unit, and the wireless transceiver,
wherein the controller, when the output condition is satisfied, outputs the mobile advertisements to the outside through the advertisement output unit, and measures the noise of the surroundings of a mobile terminal by using the noise measuring unit when the mobile advertisements is outputted to the outside to transmit the measured value to the advertisement relay server through the wireless transceiver, so that the advertisement relay server receives the measured noise, and changes it into a weight, and computes and manages an advertisement result classified by members who outputted the mobile advertisements.

22. A mobile advertisement system, comprising:
a mobile terminal including an advertisement output unit outputting a mobile advertisements made of one or more among media consisted of a taste, a smell, a sound, an image or the combinations of them to the outside;
a support server which stores and manages a setting information on a population number existing within a specified range of the surroundings use of the mobile terminal, or a noise consisted of a smell, a sound, an image or the combinations of them according to the location of the mobile terminal; and
an advertisement relay server which collects the mobile advertisements from an advertiser's terminal to manage with a member information,
wherein the advertisement relay server transmits the mobile advertisements to the mobile terminal and manages a transmission list, and decides an output condition of the transmitted mobile advertisements, wherein the mobile terminal outputs the mobile advertisements to the outside through the advertisement output unit, when the output condition is satisfied, wherein the support server transmits the setting information according to the location of the mobile terminal when the mobile advertisements is outputted, wherein the advertisement relay server receives the setting information and changes it into a weight to compute and manage an advertisement result classified by members who outputted the mobile advertisements.

23. A mobile advertisement system, comprising:
a mobile terminal including an advertisement output unit outputting a mobile advertisements made of one or more among media consisted of a taste, a smell, a sound, an image or the combinations of them to the outside;
a support server which measures and manages a population number existing within a specified range of the surroundings use of the mobile terminal according to the location of the mobile terminal; and
an advertisement relay server which collects the mobile advertisements from an advertiser's terminal to manage with a member information,
wherein the advertisement relay server transmits the mobile advertisements to the mobile terminal and manages a transmission list, and decides an output condition of the transmitted mobile advertisements, wherein the mobile terminal outputs the mobile advertisements to the outside through the advertisement output unit, when the output condition is satisfied, wherein the support server transmits the population number information which is measured according to the location of the mobile terminal when the mobile advertisements is outputted, wherein the advertisement relay server receives the population number information and changes it into a weight to compute and manage an advertisement result classified by members who outputted the mobile advertisements.

24. A mobile terminal for mobile advertisement, comprising:
a storage which stores a mobile advertisements made of one or more among media consisted of a taste, a smell, a sound, an image or the combinations of them;
an advertisement output unit which outputs the mobile advertisements to the outside according to a given output condition;
a population number measuring unit which measures the number of population existing within a specified range of the surroundings;
a wireless transceiver which communicates with an advertisement relay server which collects the mobile advertisements from an advertiser's terminal to manage with a member information; and
a controller which controls an overall control of a device by connecting to the storage, the advertisement output unit, the population number measuring unit, and the wireless transceiver,
wherein the controller measures the population number of the surroundings of the mobile terminal by using the population number measuring unit, and monitors whether the measured population number exceeds a given value, while in case the measured population number exceeds the given value, compulsively receiving the mobile advertisements from the advertisement relay server, and, in case the output condition is satisfied, outputting the mobile advertisements to the outside through the advertisement output unit and transmits an output list of the mobile advertisements to the advertisement relay server, so that the advertisement relay server is able to compute and manage an advertisement result classified by members who admitted the compulsive transmitting.

25. A mobile terminal for mobile advertisement, comprising:
a storage which stores a mobile advertisements made of one or more among media consisted of a taste, a smell, a sound, an image or the combinations of them;
an advertisement output unit which outputs the mobile advertisements to the outside according to a given output condition;
a noise measuring unit measuring a noise consisted of a smell, a sound, an image or the combinations of them existing within a specified range of the surroundings;
a wireless transceiver which communicates with an advertisement relay server which collects the mobile advertisements from an advertiser's terminal to manage with a member information; and
a controller which controls an overall control of a device by connecting to the storage, the advertisement output unit, the noise measuring unit, and the wireless transceiver,
wherein the controller measures the noise of the surroundings of the mobile terminal by using the noise measuring unit, and monitors whether the measured noise exceeds a given value, while in case the measured noise exceeds the given value, compulsively receiving the mobile advertisements from the advertisement relay server, and, in case the output condition is satisfied, outputting the mobile advertisements to the outside through the advertisement output unit to transmits an output list of the mobile advertisements to the advertisement relay server, so that the advertisement relay server is able to compute and manage an advertisement result classified by members who admitted the compulsive transmitting.

26. The mobile advertisement method of claim 2, wherein the advertisement relay server sets up a different hourly weight according to a time slot when the mobile advertisements is outputted; and reflects it in the calculation of the advertisement result and wherein the mobile terminal further comprises an output information monitoring unit which monitors at least one output information among an output level of outputting the mobile advertisements by the advertisement output unit, an output number of the mobile advertisements, and an output time of the mobile advertisements, wherein the advertisement relay server receives the output information from the mobile terminal to reflect in the calculation of the advertisement result.

27. The mobile advertisement method of claim 3, wherein the advertisement relay server sets up a different hourly weight according to a time slot when the mobile advertisements is outputted; and reflects it in the calculation of the advertisement result and wherein the mobile terminal further comprises an output information monitoring unit which monitors at least one output information among an output level of outputting the mobile advertisements by the advertisement output unit, an output number of the mobile advertisements, and an output time of the mobile advertisements, wherein the advertisement relay server receives the output information from the mobile terminal to reflect in the calculation of the advertisement result.

28. The mobile advertisement method of claim 4, wherein the advertisement relay server sets up a different hourly weight according to a time slot when the mobile advertisements is outputted; and reflects it in the calculation of the advertisement result and wherein the mobile terminal further comprises an output information monitoring unit which monitors at least one output information among an output level of outputting the mobile advertisements by the advertisement output unit, an output number of the mobile advertisements, and an output time of the mobile advertisements, wherein the advertisement relay server receives the output information from the mobile terminal to reflect in the calculation of the advertisement result.

29. The mobile advertisement method of claim 5, wherein the advertisement relay server sets up a different hourly weight according to a time slot when the mobile advertisements is outputted; and reflects it in the calculation of the advertisement result and wherein the mobile terminal further comprises an output information monitoring unit which monitors at least one output information among an output level of outputting the mobile advertisements by the advertisement output unit, an output number of the mobile advertisements, and an output time of the mobile advertisements, wherein the advertisement relay server receives the output information from the mobile terminal to reflect in the calculation of the advertisement result.

30. The mobile advertisement method of claim 6, wherein the advertisement relay server sets up a different hourly weight according to a time slot when the mobile advertisements is outputted; and reflects it in the calculation of the advertisement result and wherein the mobile terminal further comprises an output information monitoring unit which monitors at least one output information among an output level of outputting the mobile advertisements by the advertisement output unit, an output number of the mobile advertisements, and an output time of the mobile advertisements, wherein the advertisement relay server receives the output information from the mobile terminal to reflect in the calculation of the advertisement result.
